(19) United States
(12) Patent Application Publication
(10) Pub. No.: US 2002/0016103 A1
(43) Pub. Date: Feb. 7, 2002

(54) Unlocking aid

(76) Inventor: Ralph Behnke, Munich (DE)

Correspondence Address: Tyco Technology Resources, Suite 450, 4550 New Linden Hill Road, Wilmington, DE, 19808, US

(21) Appl. No.: 09/790,278

(22) Filed: Feb. 22, 2001

(30) Foreign Application Priority Data
Feb. 23, 2000 (EP) 00103751.4

(51) Int. Cl. H01R 12/24

(52) U.S. Cl. 439/493

(57) ABSTRACT

An unlocking aid for unlocking contacts which are attached to a line and which are received in a housing by way of a respective primary latching mechanism wherein the unlocking aid is integrated in the plug and constructed such that all the primary latching mechanisms of the contacts can be released at the same time.

### BACKGROUND OF THE INVENTION

The invention relates to an unlocking aid for unlocking contacts which are attached to a line and retained in a housing by a primary latch mechanism.

### DESCRIPTION OF THE PRIOR ART

Primary latch mechanisms are typically constructed on the contacts in the form of outwardly protruding latching springs which reach behind an edge in the housing of the plug. Such primary latch mechanisms can typically only be released using sharp objects which bend the latching springs downwards, insofar as they are accessible from the outside at all. In so doing, however, the latching springs are usually plastically deformed so that either they subsequently have to be bent back again or the contacts cannot be re-used.

If a plurality of contacts are connected to a line an retained in a housing using primary latching mechanisms, then in order to separate the housing from the line or to separate the contacts from the housing all of the primary latching mechanisms have to be unlocked at the same time. Using a single object, this is only possible if the primary latching mechanisms are destroyed or the latching springs are plastically deformed.

A special tool for unlocking the contacts is therefore necessary, this special tool making it possible to release all the primary latching mechanisms at the same time. Since there are a plurality of housings and the contacts are not always arranged at the same spacing from one another, there is no universal tool which can be used to unlock the contacts. Thus, a separate unlocking tool is required for each type of housing. Since the assembly engineer seldom has the appropriate unlocking tool at hand, the contacts are usually damaged.

### SUMMARY OF THE INVENTION

The object of this invention is therefore to provide an unlocking aid for unlocking contacts which are attached to a line and which are each received in the housing with a primary latching mechanism such that the assembly engineer always has an unlocking aid to hand and damage to the contacts is avoided.

This object is achieved in accordance with the invention in that a) the unlocking aid is integrated in the housing, and b) all the primary latching mechanisms of the contacts can be released at the same time using the unlocking aid.

As a result of arranging the unlocking aid in the housing, the assembly engineer always has the appropriate unlocking aid available. Thus, the assembly engineer will not use any auxiliary tool, which always entails a risk of damaging the contacts. Because all the primary latching mechanisms of the contacts can be released at the same time using the unlocking aid, the housing can easily be separated from the line with the contacts attached.

Preferably, the primary latching mechanisms are constructed in the form of latching springs on the contacts, and windows through which the unlocking aid presses the latching springs down to unlock them are provided in the housing at the locations of the primary latching mechanisms.

In accordance with a preferred embodiment, the unlocking aid is constructed in the form of a part which is separable from the plug, such as the secondary locking member for the contacts.

Similarly, it is also possible to construct the unlocking aid in one piece with the housing and to release the primary latching mechanisms of the contacts only by way of a pivotal mechanism.

Further advantageous embodiments of the invention are disclosed in the sub-claims.

### BRIEF DESCRIPTION OF THE DRAWINGS

FIG. 1 shows an oblique view of a plugging connection with an integrated unlocking aid;

FIG. 2 shows the plugging connection according to FIG. 1 in an exploded view;

FIG. 3 shows the view according to FIG. 2 of the unlocking aid as used to release the primary latching mechanisms; and

FIGS. 4 to 6 show the unlocking procedure, in each case in a sectional illustration.

### DETAILED DESCRIPTION OF THE PREFERRED EMBODIMENT

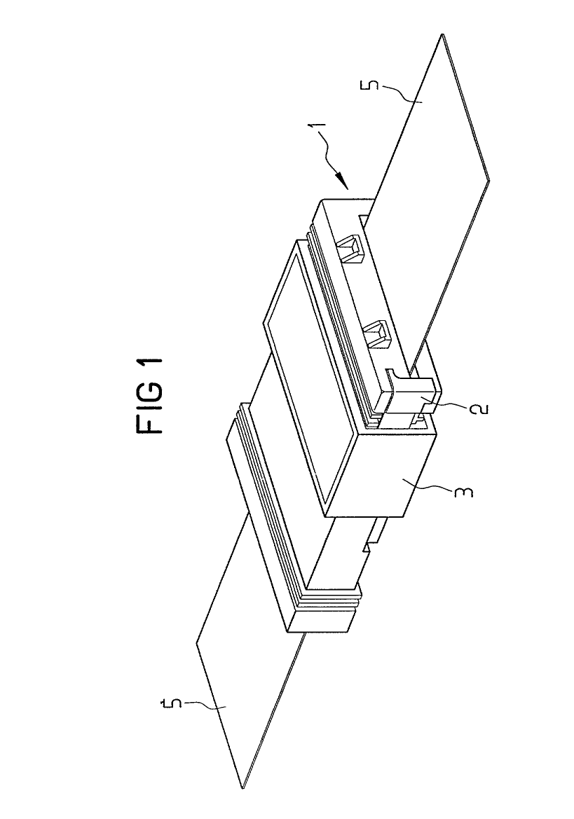

FIG. 1 illustrates a plugging connection having the unlocking aid 1 according to the invention. The plugging connection comprises a housing 2 and a mating plug 3, each of which is connected to a line 5 by way of contacts 4 (not illustrated in FIG. 1). In this example embodiment, the line 5 is constructed in the form of a flexible line, but could equally well be a low-profile (flat) line with a plurality of cores (leads) arranged next to one another.

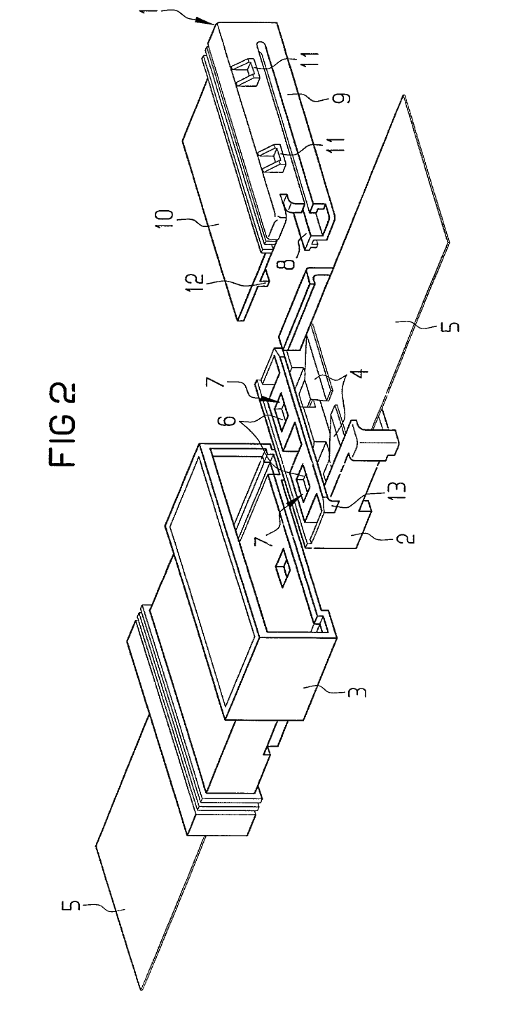

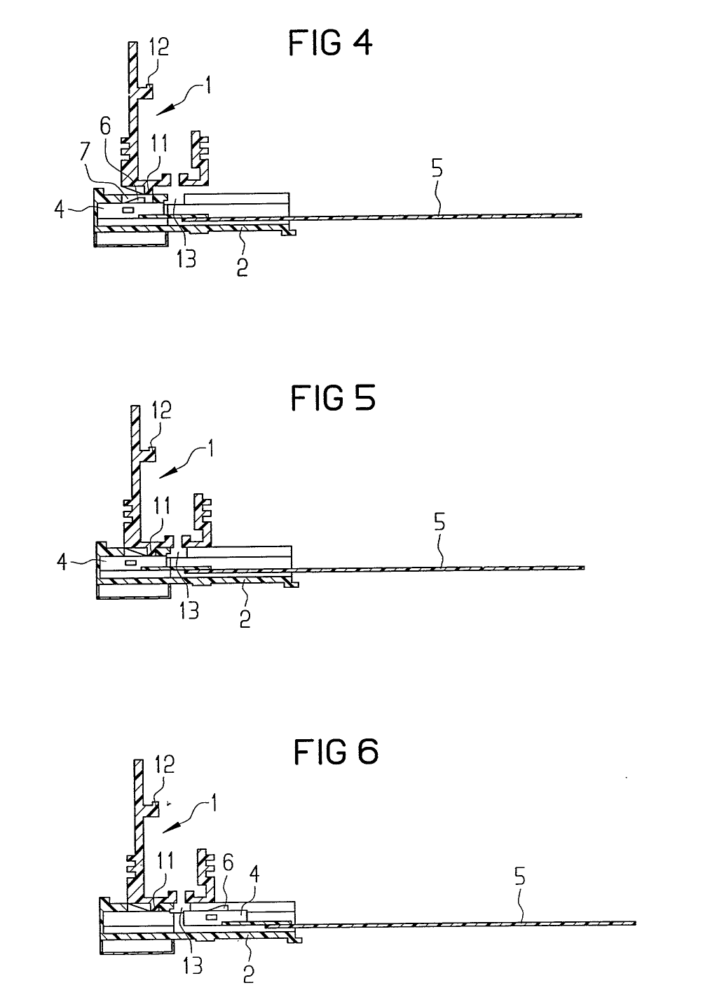

FIG. 2 shows the plugging connection according to FIG. 1 in an exploded illustration. In this illustration, the contacts 4 attached to the line 5 are visible. Constructed on the contacts 4, in the form of a primary latching mechanism 6, is a latching spring which latches into the corresponding windows 7 when the contacts 4 are inserted into the housing 2 (see also FIG. 4 in this connection). The unlocking aid 1 is constructed to be separable from the housing 2 and may be pushed onto the housing 2 as illustrated in FIG. 1, from the terminal side, that is to say from the side on which the line 5 is brought up to the housing 2. The unlocking aid is substantially U-shaped in cross-section and comprises a base wall 8, a rear wall 9 and a top wall 10. Arranged on the rear wall 9 are two protrusions 11 which are spaced from one another by the same amount as the windows 7 are in the housing 2. The protrusions 11 are dimensioned such that they may be inserted through the windows 7 from above.

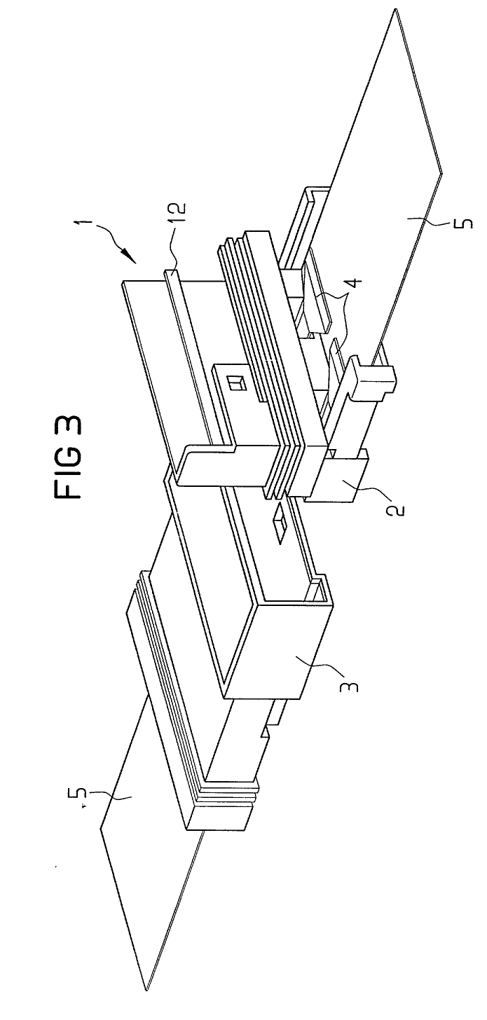

To unlock the primary latching mechanism 6, the unlocking aid 1 as illustrated in FIG. 2 is drawn off the housing 2 and placed on the housing 2 from above as illustrated in FIG. 3 such that the protrusions 11 release the primary latching mechanism 6 through the windows 7. FIGS. 4 to 6 illustrate the three phases of release of the primary latching mechanism, with the housing 2, the unlocking aid 1 and the line 5 each being illustrated in section.

In FIG. 4, the unlocking aid 1 is placed on the housing 2 with the protrusions 11 being inserted into the windows 7. The primary latching mechanism 6 of the contacts 4, which is constructed in the form of a latching spring, is still latched in the windows 7 in the state illustrated in FIG. 4.

In FIG. 5, the unlocking aid 1 already presses down on the housing 2, as a result of which the primary latching mechanism 6 is pressed into the contact 4 by means of the protrusions 11 and the contact 4 can be withdrawn from the housing 2, as illustrated in FIG. 6.

The unlocking aid 1 abuts by means of its rear wall laterally with respect to the protrusions 11 against the upper side of the housing 2, as illustrated in FIGS. 5 and 6. This ensures that the primary latching mechanism 6 is only pressed down by an amount equivalent to the height of the protrusions 11 and thus the possibility of over-bending of the primary latching mechanism 6 is eliminated. over-bending would carry a risk of the primary latching mechanism 6 being plastically deformed and the contacts 4 no longer being securely fixed when they are re-inserted into the housing 2.

In the example embodiment illustrated, the unlocking aid 1 is at the same time constructed to form a secondary securing means. For this purpose, the unlocking aid 1 has a continuous rib 12 on the underside of the top wall 10, and this continuous rib 12 is inserted into a corresponding recess 13 in the housing 2 in order to lock the contacts 4 in the housing 2 and hence (see FIGS. 4 and 5) reaches form-fittingly (in an interlocking manner) behind the contacts 4. As illustrated in FIG. 1, the housing 2 is inserted into the mating plug 3 of box-shaped construction with the unlocking aid 1 pushed on, so that it is no longer possible to lift off the unlocking aid upwards, and thus the secondary securing means also cannot be separated when the plugging connection is made.

The invention is not restricted to the example embodiment illustrated. For example, it is also possible to mount the unlocking means on a further part separable from the housing 2, or to leave the unlocking aid connected to the housing 2, so that for example the protrusions on the unlocking aid are pressed into the windows 7 in order to release the primary latching mechanism 6 only by way of a flap-type mechanism.

I/we claim:

1. An electrical connector comprising a housing having cavities therein for receiving respective contacts and retaining the respective contacts by a corresponding primary latching mechanism and an unlocking aid integrated with the housing and constructed to release the primary latching mechanisms of multiple cavities together.

2. The electrical connector of claim 1 wherein the primary latching mechanism includes a shoulder along the cavity and a latching spring on the respective contact that engages the shoulder.

3. The electrical connector of claim 2 wherein the housing includes windows into the cavities positioned to correspond to the primary latching mechanism to receive the unlocking aid.

4. The electrical connector of claim 1 wherein the unlocking aid is formed on a secondary locking member of the connector.

5. The electrical connector of claim 3 wherein the unlocking aid is separable form the housing.

6. The electrical connector of claim 5 wherein the unlocking aid includes protrusions corresponding to the windows.
